(19) United States
(12) Patent Application Publication
(10) Pub. No.: US 2010/0082684 A1
(43) Pub. Date: Apr. 1, 2010

(54) METHOD AND SYSTEM FOR PROVIDING PERSONALIZED WEB EXPERIENCE

(75) Inventors: Elizabeth F. Churchill, San Francisco, CA (US); David M. Ishimaru, San Francisco, CA (US); Athellina Athsani, San Jose, CA (US)

Correspondence Address: Yahoo! Inc., c/o Kenyon & Kenyon LLP, 333 W. San Carlos Street, Suite 600, San Jose, CA, 95110, US

(73) Assignee: YAHOO! INC., Sunnyvale, CA (US)

(21) Appl. No.: 12/243,910

(22) Filed: Oct. 1, 2008

(51) Int. Cl. G06F 17/30

(52) U.S. Cl. 707/784; 707/E17.059

(57) ABSTRACT

A system and method which may generate and/or maintain a signature profile for a user. The signature profile may be a representation or a symbol of a user which may yield to different kinds of searches. A signature processor server may generate an initial signature profile with user-supplied materials, including but not limited to: audio clips, video clips, and images. A crawler server may use the initial signature profile to mine the Internet, obtain web content relevant to the initial signature profile, and present the relevant web content to the user. The signature processor server may receive the user's feedback on the relevant web content so as to update and refine the signature profile.

### BACKGROUND

1. Field of the Invention

The present invention relates generally to Internet search, and more particularly to personalized Web experiences.

2. Description of Related Art

The Internet has become a major platform for distributing and sharing information. Every day, text files, pictures, audio clips, video clips, MP3 files and other types of web content may be uploaded to the Internet. A user may be interested in the web content, but may not always have time to search for it nor have the capability to find relevant information in the right places.

### BRIEF DESCRIPTION OF THE DRAWING FIGURES

Embodiments of the present invention are described herein with reference to the accompanying drawings, similar reference numbers being used to indicate functionally similar elements.

FIG. 1 illustrates a system for providing personalized web experience according to one embodiment of the present invention.

FIG. 2A-2B illustrate screenshots of a method for providing personalized web experience according to one embodiment of the present invention.

FIG. 3 illustrates a flow chart of a method for providing personalized web experience according to one embodiment of the present invention.

### DETAILED DESCRIPTION

The present invention provides a system and method which may generate and/or maintain a signature profile for a user. The signature profile may be a collection of data derived from system or user-generation patterns. The patterns may be representation or concept of an entity that may be identified by certain types of data (e.g. if the entity is the user, then the data used for creating a signature profile of the user may include an image pattern of the types of images the user creates (signature profile of the user's artwork), images of the user (signature profile of the user's images), keywords, feature extraction of an audio or video clip, or her name in tags or on a web page) which may yield to different kinds of searches (e.g. image match search, text string search, or feature extraction search).

A signature processor server may generate an initial signature profile with user-supplied documents, including but not limited to: audio clips, video clips, and images. Alternatively, the user may upload data or files that may be used as the initial signature profile. A crawler server may use the initial signature profile to mine the Internet, obtain web content relevant to the initial signature profile, and present the relevant web content to the user. The signature processor server may receive the user's feedback on the relevant web content so as to update and refine the signature profile. The system may help a user to find information pertaining to specific signature profile using pattern recognition technologies or matching algorithms. The signature profile may be used to mine the Internet to find web content matching a user's signature profile and recommend the matching web content to the user. Since the signature profile defines a user's search interests, it may also be used for advertisement targeting or social networking. The invention may be carried out by computer-executable instructions, such as program modules. Advantages of the present invention will become apparent from the following detailed description.

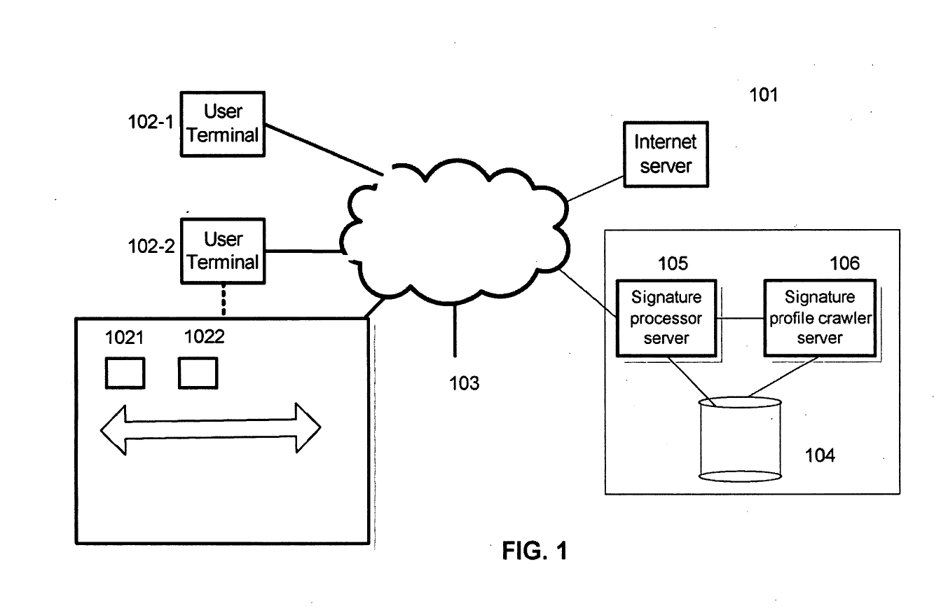

FIG. 1 illustrates a system for providing personalized web experience according to one embodiment of the present invention. As shown, an Internet server 101 may communicate over a network 103 with a number of user terminals 102-1, 102-2, . . . 102-n. The Internet server 101 may be a computer system and may control the operation of a website, which may be, e.g., a blog, a social networking website or a media management website.

Network connectivity may be wired or wireless, using one or more communications protocols, as will be known to those of ordinary skill in the art.

The user terminals 102 may be personal computers, handheld or laptop devices, microprocessor-based systems, set top boxes, or programmable consumer electronics. A user terminal 102 may include one or more of a screen, an input device, a processing unit 1021, memory devices 1022, and a system bus coupling various components in the computer system. An operating system of the user terminal may respond to a user input by managing tasks and internal system resources and processing system data. A user terminal may have a browser application configured to receive and display web pages, which may include text, graphics, multimedia, etc. The web pages may be based on, e.g., HyperText Markup Language (HTML) or extensible markup language (XML).

A user terminal may have a tracking application, stored in one of the memory devices 1022 and collecting user browsing activity information. The tracking application may tag each location a user visited with its URL, start time, end time, content information and/or matched pattern. The content information may be relevant keywords, images, audio, video, photo, biometric data, metadata, tags and/or text as well as specific keywords, images, audio, video, photo, biometric data, metadata, tags, writing pattern and/or text. The matched pattern information may be relevant, specific, implicit or explicit matches of keywords, images, audio, video, photo, biometric data, metadata, tags and/or text. The tracking application may forward the user browsing activity information to a signature processor server 105 over the network 103.

A crawling application may be stored in one of the memory devices 1022, and may crawl web content on websites a user specified, e.g., the user's own blog, a media management website, a social networking website, etc. The crawling application may forward a copy of obtained web content to the signature processor server 105 over the network 103. Alternatively, it may index obtained web content at relevant locations, e.g., an online photo management website to which the user has uploaded photos. The index may include a URL and content information of the websites. The crawling application may also be given user ID and password information to crawl within particular websites so that, e.g., only a particular user's account on the website, instead of the entire website, may be indexed.

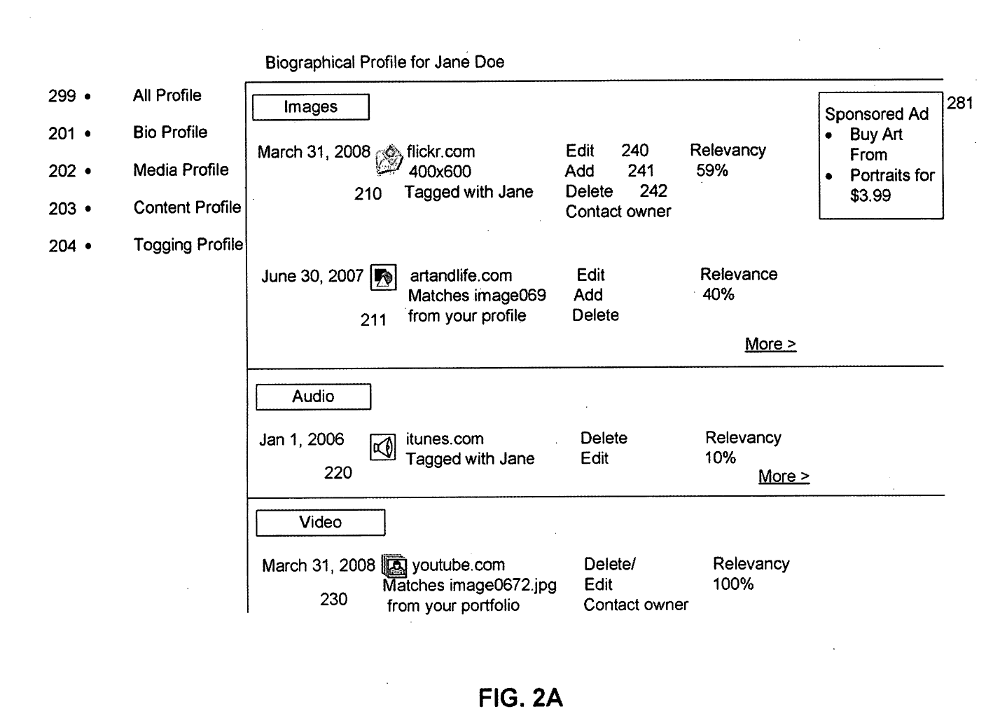

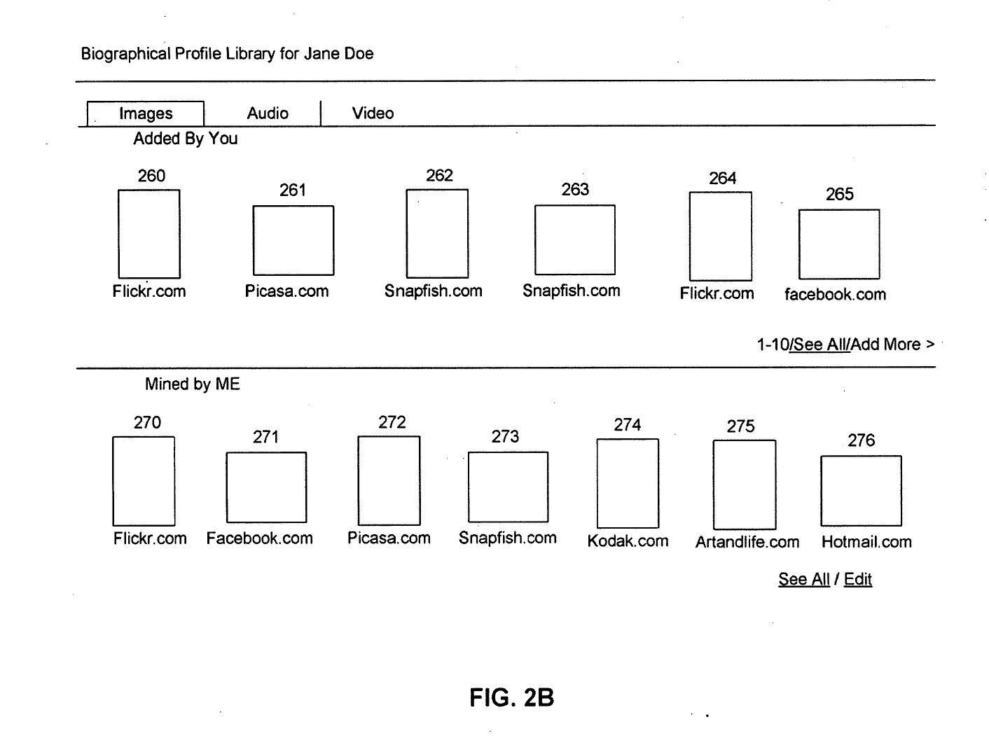

The signature processor server 105 may generate and maintain one or more signature profiles for a user. The user may choose what signature profile she wants the signature processor server 105 to create and maintain for her. For each signature profile, she may provide some materials. In the embodiment shown in FIG. 2A, the user may want the system to keep four signature profiles for her: a Biographical Profile, a Media Profile, a Content Profile and a Metadata Profile. In the Biographical Profile, the user may provide some materials about herself, e.g., her name, her photos, a song sung by her, a video clip showing her cooking. In the Media Profile, the user may upload some of her favorite songs or videos, or the user may upload songs she sang or videos she created. In the Content Profile, the user may upload articles she wrote. In the Metadata Profile, the user may create metadata on some web content. It should be understood that the user may use the signature processor server 105 to keep more or fewer signature profiles.

The signature processor server 105 may generate an initial signature profile, save it in a database 104 together with the user supplied materials, and forward it to a signature profile crawler server 106. In one embodiment, the signature processor server 105 may generate initial signature profiles from the user-supplied materials or explicit user-specified content. For example, from photos a user has provided, the signature processor server 105 may abstract facial features and include the facial features in an initial signature profile. From audio clips a user has provided, the signature processor server 105 may obtain feature extractions of the music and include the feature extraction in an initial signature profile. From images a user has provided, the signature processor server 105 may obtain image patterns of the images and include the image patterns in an initial signature profile.

In one embodiment, the signature processor server 105 may directly include user supplied information in the signature profile. For example, if the user supplied materials include “Mozart” or “Van Gogh,” the signature processor server 105 may include these keywords in the initial signature profile.

The signature processor server 105 may also generate an initial signature profile from implicit or relevant content. In one embodiment, the signature processor server 105 may generate signature profiles from user browsing activity information. For example, from the music a user has downloaded, the signature processor server 105 may determine the type of music the user is interested in, e.g., high tone, low tone, classical, pop and jazz, and include such information in the initial signature profile.

In one embodiment, the signature processor server 105 may interpolate between the user supplied materials in different profiles, e.g., the Biographical Profile 201, the Media Profile 202, the Content Profile 203 and the Metadata profile 204. For example, if the user has provided the keyword “Mozart,” and the browsing activity information indicates that the user is interested in classical music, the interpolation may be “symphonic” or “piano.” The interpolations may be combined with the user supplied materials to make the signature profiles closer to what the user may really be interested in.

In one embodiment, the signature processor server 105 may abstract, e.g., photography style, image style, and writing style (e.g., text analysis for structural similarities) and use them to supplement the signature profile.

The signature processor server 105 may keep updating and refining the signature profile with user input and user activity information. When the signature processor server 105 receives browsing activity information or user generated content (UGC) from a user after the initial signature profile is generated, it may access the database 104 for the initial signature profile, use the newly received information to update the initial signature profile, and then store the newly received information and the updated signature profile into the database 104. The signature processor server 105 may then forward the signature profile to a signature profile crawler server 106.

The signature profile crawler server 106 may mine the web with the signature profile, bring back web content relevant to the signature profile, save the relevant web content in the database 104, and ask the user whether she wants to add the returned web content to her signature profile. The signature profile crawler server 106 may perform different types of search, including but not limited to: text string search against tags, content, etc.; text-in-image, image-in-image, or image, audio or video match search; media pattern match search; or facial feature match search.

FIG. 2A illustrates a screenshot including some web content returned by the signature profile crawler server 106 according to one embodiment of the present invention. In the shown embodiment, a user Jane Doe wants to get web content about herself and has provided images, text, audio or video about herself to the signature processor server 105. As a result, the relevant web content returned by the signature profile crawler server 106 may be web content about Jane Doe. It should be understood that the search result may be web content relevant to another user if the user Jane Doe is looking for information about that user and provided information about that user to the signature processor server 105.

In one embodiment, the signature profile crawler server 106 may have mined the web, obtained some web content relevant to the user's Biographical Profile, and displayed the returned web content in a number of sections, e.g., an image section, an audio section, and a video section. The image section may include two images 210 and 211 relevant to photos the user Jane Doe provided to the signature processor server 105. The image 210 may be a photo from www.flickr.com, which is tagged with the user Jane Doe's name; and the image 211 may be a photo from www.artandlife.com which has the facial features of one of Jane Doe's photos provided to signature processor server 105. In the audio section, the signature profile crawler server 106 may have obtained a song 220 from www.itunes.com which is tagged with the user's name, Jane Doe. In the video section, the signature profile crawler server 106 may have obtained a video clip 330 from www.youtube.com which is relevant to a photo she provided.

Returned web content may come with a relevancy rating indicating how relevant it is to a user's signature profile. In the embodiment shown in FIG. 2A, the relevancy ratings of the returned web content are 59%, 40%, 10% and 100% respectively.

“Edit”, “Add” and “Delete” buttons 240, 241 and 242 may be provided for the returned web content so that the user may apply the returned web content to her signature profile or delete it. For example, if the song tagged by Jane Doe is not sung by the user Jane Doe, but by a singer with the same name, the user may click on the “Delete” button 242 to delete it. Otherwise, she may click the “Add” button 241 to add this song to her signature profile. The user may use the “Edit” button 240 to change relevancy rating of the web content. A “Contact the Owner” button may also be provided so that the user may contact the owner of the returned web content if she likes.

FIG. 2B illustrates a screenshot including some web content returned by the signature profile crawler server 106 according to one embodiment of the present invention. As shown, the user Jane Doe added images 260 to 265 to the image section of her Biographical Profile. These images may be from, e.g., www.flickr.com, www.picasa.com, www.snapfish.com, or www.facebook.com. The signature profile crawler server 106 may mine the Internet and return images 270-276, each of which may be relevant to one of the images 260-265 supplied by the user. The user Jane may keep the ones she likes and delete those she does not.

Thus, the signature processor server 105 may create signature profiles for the signature profile crawler server 106 to search the Internet for relevant web content, and the signature profile crawler server 106 may mine the web to update/maintain the signature profile. By performing the user's “Add”, “Delete” or “Edit” instructions, the signature processor server 105 may modify the signature profile with web content returned by the signature profile crawler server 106 to further improve its precision. The signature profile may be updated and refined each time the tracking application or the crawling application collects something, and becoming closer and closer to what the user is interested in. The signature profile may range from:

1) Personal Biographical Profile
Explicit as: images, photos, audio and/or video of the user Jane Doe from various angles, various times of the year, or various periods of time;
Matchable as: pattern matching content from other users, tagged with the user Jane Doe's name;
Obscure as: DNA strings or scan matches (e.g., from www.23andme.com); retina, ears or fingerprint pattern matching; facial feature matching, and media tagging patterns by the user;

2) Personal Media Profile (Images, Photos, Audio, Video)
Explicit as: media created, shared or verified by the user or belong to the user; and media signature pattern as derived by system, or edited by the user or other users;
Matchable as: media tagged with the user as the owner and uploaded by other users;
Obscure as: media signature patterns tagged to be in the style of the user by the user or other users;

3) Personal Content Profile (Tagging, Authoring, or Financial)
Explicit as: tags, text and/or financial information created and verified by the user to belong to the user; tags, text or financial activity signature pattern as derived by the system and edited by the user;
Matchable as: tags, text and/or financial activity signature pattern as derived by the system and edited by the other users;
Obscure as: tags, text and/or financial activity signature patterns tagged to be in the style of the user by the user or other users.

Although the signature processor server 105 and the signature profile crawler server 106 are shown as two different servers, it should be understood that they may be parts of one server or mining engine (ME), or their functions may be performed by one server or mining engine. The mining engine may be the backend of a stand-alone application or as a part of a personalized web, e.g., my.yahoo.

A user may opt to publicize her signature profile, opt out or provide access to a selected group of users.

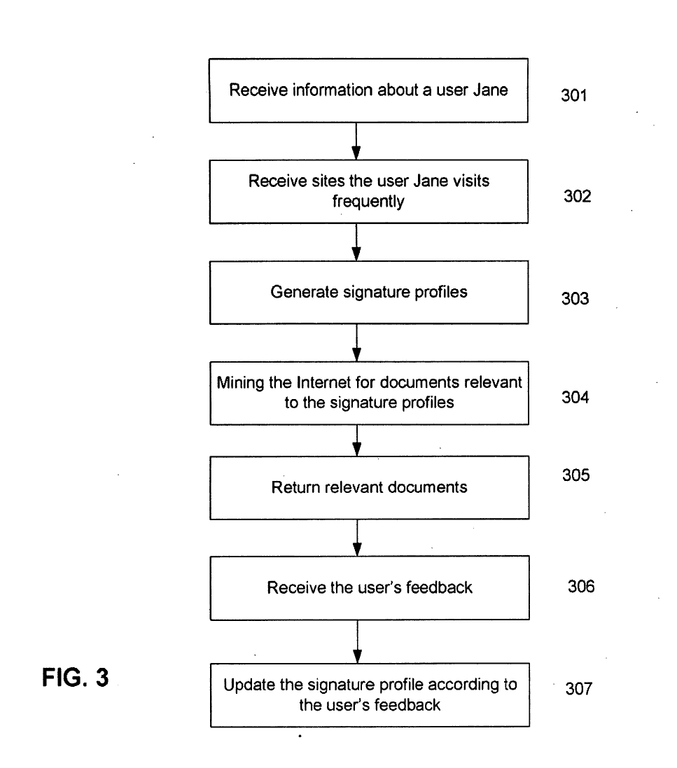

FIG. 3 illustrates a flow chart of a method for providing personalized web experience according to one embodiment of the present invention, used in the system shown in FIG. 1.

At 301, a user Jane Doe may supply some materials about herself to the signature processor server 105. As shown in FIG. 2A, the user may want the signature processor server 105 to keep four signature profiles for her: a Biographical Profile, a Media Profile, a Content Profile and a Metadata Profile. In the Biographical Profile, the user may provide some basic information about herself, e.g., her name, her picture, a song sung by her, a video clip showing her cooking. In the Media Profile, the user may upload some of her favorite songs or videos. In the Content Profile, the user may upload articles she wrote. In the Metadata Profile, the user may put in her tags on some web content.

At 302, the user Jane may enter websites she visits frequently or websites she is most active at, so that the signature processor server 105 may review multimedia files on those websites. Those multimedia files may contain explicit user biographical, media and/or content profiles based on tags, description or self/community-identification which may be used to augment the user's signature profile. For example, the user may register with Flickr, Facebook, Yahoo Groups, and/or Gizmodo. The signature processor server 105 may keep track of all user activities on these websites to collect information for the user's signature profiles.

At 303, the signature processor server 105 may review the materials supplied by the user at 301 and/or user browsing activity information obtained at 302 and generate user biographical, media, content and metadata profiles. The signature profiles may include text strings, facial features, pattern extraction of audio or video clips, image patterns, etc.

At 304, the signature profile crawler server 106 may search the Internet for web content relevant to the user's signature profile. The web content may be various types of documents, e.g., images, pictures, video clips, audio clips, and icons. The signature profile crawler server 106 may refine its search by looking at the user's common activities, e.g., her events, activity diary, journal or blog. If the user Jane typically attends Social Graph conferences all over the world, the signature profile crawler server 106 may give higher priority to multimedia files with social graph conference related tags.

At 305, the signature profile crawler server 106 may return web content relevant to the user's signature profile and display the web content. As shown in FIG. 2A, the returned web content may be displayed together with its relevancy rating, URL, owner, upload time, and/or relationship with the user's signature profile. The signature profile crawler server 106 system may automatically categorize the returned web content into the a number of categories, e.g., Biographical Profile, Media Profile, and Content Profile shown in FIG. 2A. Each of these profiles may be further broken down into categories such as, images, audio and video for the Media Profile; and blogs, books, news, paper and products for the Content Profile.

At 306, the signature processor server 105 may receive the user's feedback on the returned web content. The user may look at the returned web content, keep what she likes and delete what she does not. The user Jane may also contact the owner of the returned web content for follow-up questions etc.

In one embodiment, the user may change the relevancy rating. For example, the signature profile crawler server 106 gives the photo 210 a relevancy rating 59%. The user Jane may change the relevancy rating to 90% if she thinks that it is more relevant.

In one embodiment, the signature profile crawler server 106 may generate biographical-profile-relevancy-to-user graphs, media-profile-relevancy-to-user graphs, or content-profile-relevancy-to-user graphs. The user Jane may edit these graphs over the course of time.

At 307, the signature processor server 105 may apply the user's edits to her signature profile to refine it. From the user's changes, the signature processor server 106 may figure out what the user is interested in.

Since the signature profile may define a user's search interests, it may be used in various types of applications. In one embodiment, it may be used as a matching tool for match making or social networking purposes, and the user Jane may be able to find another user who has similar interests. For example, if Jane likes Japanese sushi, she may be able to find other users who like Japanese sushi too, and share information or make friends with them.

In another embodiment, the signature profile may be used as a recommendation tool. The signature profile crawler server 106, or another mining engine, may mine the Internet to find web content matching the user's signature profile and recommend the matching web content to the user. For example, if the signature profile indicates that the user Jane likes Japanese sushi, the signature profile crawler server 106 may mine for web content about how to make Japanese sushi or sushi restaurant reviews and recommend the content to the user Jane.

In another embodiment, the signature profile may be used for advertisement targeting. For example, when the signature profile indicates that the user Jane is interested in photography, advertisements about frames and portraits may be displayed on the screen shown in FIG. 2A.

In another embodiment, the signature profile may be used by a user as a portfolio right management tool. When an audio clip of a song of the user Jane is included in her signature profile, she may keep track of who has downloaded her audio clip, where it is kept, and how it is used.

In another embodiment, the signature profile may be used to manage tagging or commenting activities. For example, the signature profile crawler server 106 may track all the comments or tagging done by the user Jane.

In one embodiment, a user may filter access to her signature profile to allow and/or restrict other users to view her signature profiles. In one embodiment, a user may allow other users to edit her signature profile. For example, a user is collecting a digital signature profile for Beethoven which may include his portraits, images, and works. The user may allow her music-fan friends to access her Beethoven signature profile and make additions, corrections or deletions. In another example, a user is collecting a digital signature profile of herself and may allow her family and friends to view, edit, or make deletions or additions to the signature profile.

Several features and aspects of the present invention have been illustrated and described in detail with reference to particular embodiments by way of example only, and not by way of limitation. Those of skill in the art will appreciate that alternative implementations and various modifications to the disclosed embodiments are within the scope and contemplation of the present disclosure. Therefore, it is intended that the invention be considered as limited only by the scope of the appended claims.

What is claimed is:

1. A method for providing personalized Web experience, said method comprising:
performing automated mining of the Internet for documents relevant to a signature profile;
displaying a document relevant to the signature profile;
receiving a first user's feedback on the relevant document; and
updating the signature profile according to the first user's feedback,
wherein the signature profile is a representation of a target user.

2. The method of claim 1, further comprising: displaying the relevant document together with its relevancy rating.

3. The method of claim 1, further comprising: applying the relevant document to the signature profile according to the user's feedback.

4. The method of claim 1, further comprising: deleting the relevant document according to the user's feedback.

5. The method of claim 2, further comprising: changing the relevancy rating according to the user's feedback.

6. The method of claim 1, wherein the signature profile is selected from the group consisting of: a demographic profile, a media profile, a content profile and a metadata profile.

7. The method of claim 1, wherein the signature profile is selected from the group consisting of: biometrical data, photo, image, audio, video, metadata, tagging, writing patterns, and content.

8. The method of claim 1, further comprising: generating the signature profile from materials provided by the first user.

9. The method of claim 1, further comprising: receiving the signature profile from the first user.

10. The method of claim 1, wherein the target user is the first user.

11. The method of claim 10, further comprising: updating the signature profile with browsing activity information of the first user.

12. The method of claim 1, further comprising: searching the Internet for web content matching the signature profile and recommending the matching web content to the first user.

13. The method of claim 1, further comprising: providing advertisements targeted at the first user using the signature profile.

14. The method of claim 1, further comprising: tracking web content uploaded to the Internet by the first user.

15. A system for providing personalized web experience, the system comprising:
a crawling unit for mining the Internet for documents relevant to a signature profile and returning a document relevant to the signature profile;
a signature processing unit for receiving a first user's feedback on the relevant document via a user interface and updating the signature profile according to the first user's feedback; and
a database for storing the signature profile,
wherein the signature profile is a representation of a target user.

16. The system of claim 15, wherein the signature processing unit applies the relevant document to the signature profile according to the first user's feedback.

17. The system of claim 15, wherein the signature processing unit deletes the relevant document according to the first user's feedback.

18. The system of claim 15, wherein the signature processing unit changes a relevancy rating associated with a relevant document according to the first user's feedback.

19. The system of claim 15, wherein the signature profile is selected from the group consisting of: a demographic profile, a media profile, a content profile and a metadata profile.

20. The system of claim 15, wherein the signature profile is selected from the group consisting of: biometrical data, photo, image, audio, video, metadata, tagging, writing patterns, and content.

21. The system of claim 15, wherein the signature processing unit generates a signature profile from materials provided by the first user.

22. The system of claim 15, wherein the crawling unit searches the Internet for web content matching the signature profile and recommends the matching web content to the first user.

23. The system of claim 15, wherein the signature profile is used to provide advertisements targeted at the first user.

24. The system of claim 15, wherein the signature profile is used to track web content uploaded to the Internet by the first user.

25. The system of claim 15, wherein the user interface allows a user to manage the signature profile.

26. The system of claim 15, wherein the user interface enables presenting documents relevant to the signature profile to a user.

27. The system of claim 15, wherein the user interface allows a user to manage access to the signature profile.

28. A computer program product comprising a computer-readable medium having instructions which, when performed by a computer, perform a method for providing personalized Web experience, said method comprising:
performing automated mining of the Internet for documents relevant to a signature profile;
displaying a document relevant to the signature profile;
receiving a first user's feedback on the relevant document; and
updating the signature profile according to the first user's feedback,
wherein the signature profile is a representation of a target user.
